(19) United States
(12) Patent Application Publication
(10) Pub. No.: US 2023/0311537 A1
(43) Pub. Date: Oct. 5, 2023

(54) PRINTING SYSTEM

(71) Applicant: SHOWA ALUMINUM CAN CORPORATION, Tokyo (JP)

(72) Inventor: Shinichi OJIMA, Bunkyo-ku, Tokyo (JP)

(73) Assignee: ALTEMIRA CO., LTD., TOKYO (JP)

(21) Appl. No.: 18/024,770

(22) PCT Filed: Sep. 14, 2021
(86) PCT No.: PCT/JP2021/033713

§ 371 Date: Mar. 5, 2023

(30) Foreign Application Priority Data
Oct. 14, 2020 (JP) 2020-173162

(51) Int. Cl. B41J 3/407; B41J 2/01

(52) U.S. Cl. CPC B41J 3/40733; B41J 2/01

(57) ABSTRACT

A printing system includes: a first printing device configured to perform printing on a can body, a second printing device provided in parallel with the first printing device and configured to perform the printing on the can body, an adjustment section configured to collect plural can bodies having undergone the printing by the first printing device and the second printing device and adjust intervals of conveyance of the plural can bodies, and a processing device configured to perform processing to form a protective layer protecting an outer surface of each of the plural can bodies obtained from the adjusting section.

### TECHNICAL FIELD

The present invention relates to a printing system.

### BACKGROUND ART

For example, Patent Document 1 discloses a printing device for seamless cans, which includes a mandrel wheel, plural rotatable mandrels provided to the mandrel wheel, and an inkjet printing station for forming a printed image at least on a body part of the outer surface of a seamless can attached to the mandrel by inkjet printing. In the printing device, the inkjet printing is performed in at least one inkjet printing station, and plural inkjet heads are arranged in the inkjet printing station.

### CITATION LIST

### Patent Literature

Patent Literature 1: Japanese Patent No. 5891602

### SUMMARY OF INVENTION

### Technical Problem

For example, plural operations may be performed on a can body, such as printing on the can body and processing to form a protective layer on the printed can body. In this case, the difference between the operating capacity per unit time of the printing device for printing on the can body and the operating capacity per unit time of the processing device for forming the protective layer on the can body may decrease efficiency of performing operations on the can body, for example, by requiring a waiting period between the devices.

It is an object of the present invention to suppress the decrease in efficiency when performing operations on can bodies.

### Solution to Problem

Under the above object, a printing system to which the present invention is applied includes a first printing device configured to perform printing on a can body; a second printing device provided in parallel with the first printing device and configured to perform the printing on the can body; an adjustment section configured to collect a plurality of can bodies having undergone the printing by the first printing device and the second printing device and adjust intervals of conveyance of the plurality of can bodies; and a processing device configured to perform processing to form a protective layer protecting an outer surface of each of the plurality of can bodies obtained from the adjusting section.

Here, the first printing device and the second printing device each may perform the printing on the can body using an inkjet head.

In addition, the adjustment section may convey the can body without holding the can body.

Moreover, the adjustment section may include: a first conveyance section configured to convey the can body using power of a driving source; and a second conveyance section provided downstream of the first conveyance section in a conveyance direction of the can body and configured to convey the can body using a conveyance path on which the can body rolls.

Furthermore, the second conveyance section may have a lower conveying speed than the first conveyance section.

In addition, the first printing device and the second printing device each may include a plurality of printing sections with a plurality of inkjet heads.

Moreover, the first printing device and the second printing device each may convey the can body along an axial direction of the can body to perform the printing on the can body, and the processing device may convey the can body in a direction intersecting the axial direction of the can body to perform the processing on the can body.

### Advantageous Effects of Invention

The present invention can suppress the decrease in efficiency when performing operations on can bodies.

### BRIEF DESCRIPTION OF DRAWINGS

FIG. 1 is an overall view of a printing system of the present embodiment.

FIG. 2 is an overall view of a printing device of the present embodiment.

FIG. 3 is an illustration diagram of a conveyance section used in the printing device of the present embodiment.

FIGS. 4A and 4B are illustration diagrams of a first printing unit and a second printing unit.

FIGS. 5A, 5B and 5C are illustration diagrams of a printing device of a modified example.

FIG. 6 is an overall view of an adjustment section of the present embodiment.

FIG. 7 is an overall view of a processing device of the present embodiment.

### DESCRIPTION OF EMBODIMENTS

Embodiments of the present invention will be described below with reference to attached drawings.

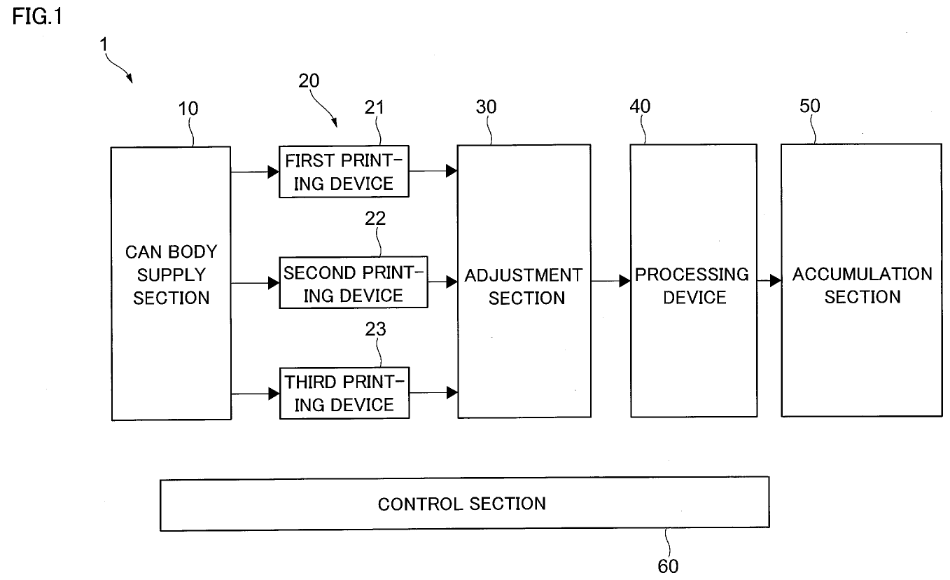

FIG. 1 is an overall view of a printing system 1 of the present embodiment.

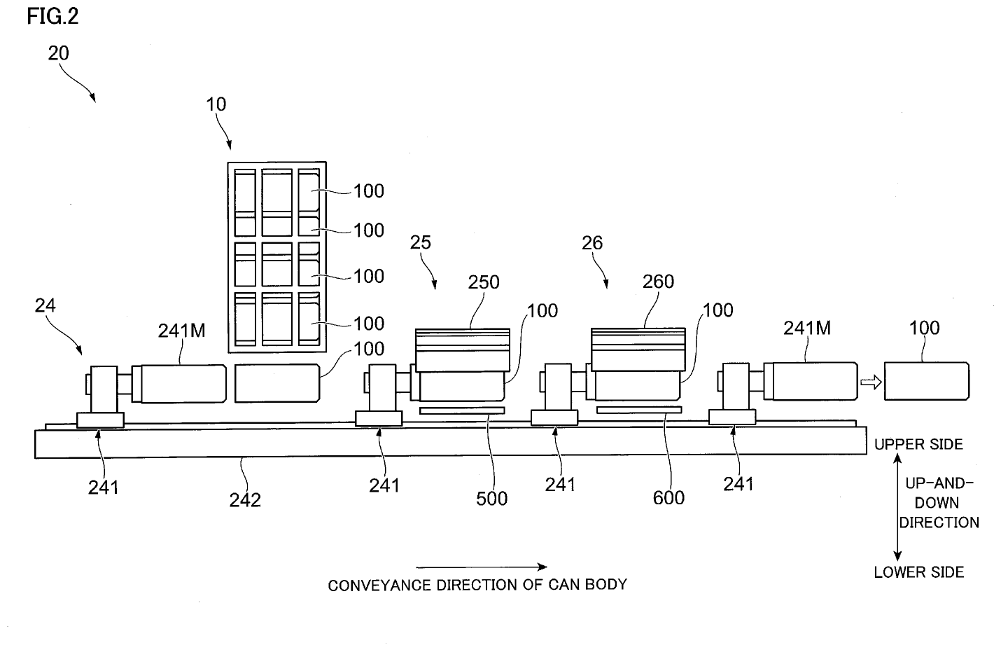

FIG. 2 is an overall view of a printing device 20 of the present embodiment.

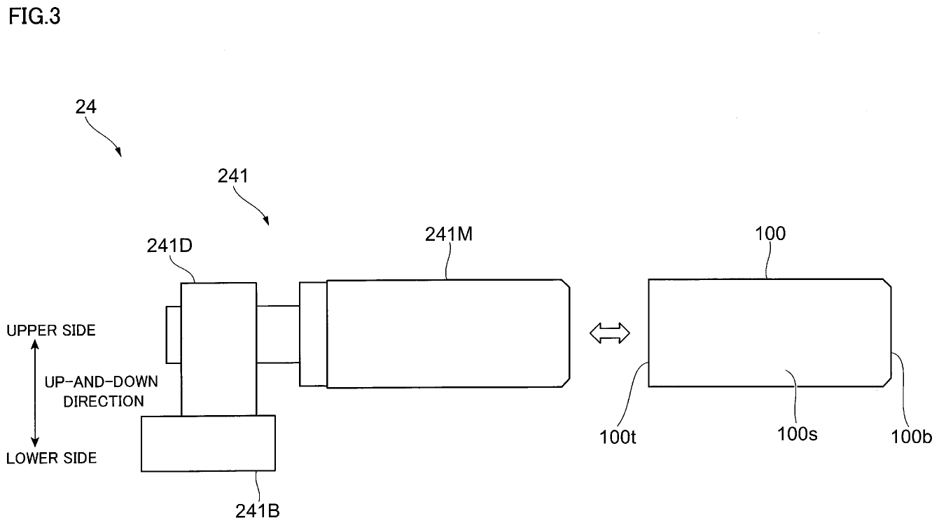

FIG. 3 is an illustration diagram of a conveyance section 24 used in the printing device 20 of the present embodiment.

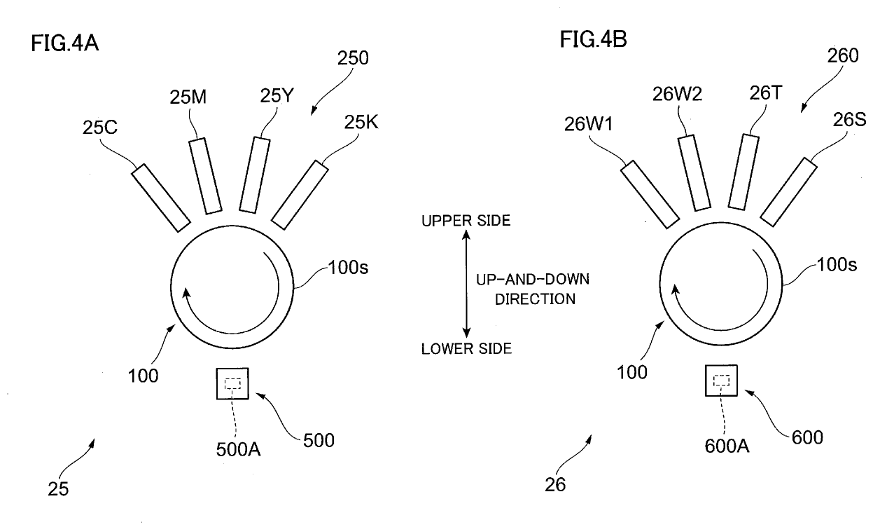

FIGS. 4A and 4B are illustration diagrams of a first printing unit 25 and a second printing unit 26.

### [Printing System 1]

As shown in FIG. 1, a printing system 1 of the present embodiment includes a can body supply section 10 that supplies plural can bodies 100 before printing to a printing device 20, which will be described later. The printing system 1 also includes a first printing device 21 that performs printing on the can bodies 100, a second printing device 22 that is provided in parallel with the first printing device 21 and performs printing on the can bodies 100, and a third printing device 23 that is provided in parallel with the first printing device 21 and the second printing device 22 and performs printing on the can bodies 100.

In the present embodiment, when the first printing device 21, the second printing device 22, and the third printing device 23 are not distinguished from each other, they are referred to as “printing devices 20” for explanation.

Furthermore, the printing system 1 includes an adjustment section 30 that adjusts intervals of conveyance of the plural can bodies 100, on which the printing has been performed, and a processing device 40 that performs processing to form a protective layer on the plural can bodies 100 whose intervals of conveyance has been adjusted. Moreover, the printing system 1 includes an accumulation section 50 that accumulates the plural can bodies 100 on which the processing has been performed by the processing device 40, and a control section 60 that comprehensively controls each component constituting the printing system 1.

It should be noted that the printing system 1 of the present embodiment includes three printing devices 20: the first printing device 21, the second printing device 22, and the third printing device 23, but the printing system 1 may include at least two printing devices 20 in parallel, and may include four or more printing devices 20 in parallel.

Hereinafter, a direction along a vertical direction is referred to as an “up-and-down direction,” a vertical upper side in the up-and-down direction is referred to as an “upper side”, and a vertical lower side in the up-and-down direction is referred to as a “lower side”.

In the printing system 1 of the present embodiment, the plural can bodies 100, on which the printing has been performed by the plural printing devices 20, are collected, the intervals of conveyance of the plural can bodies 100 are adjusted by the adjusting section 30, and the plural can bodies 100 whose intervals of conveyance has been adjusted by the adjustment section 30 are sequentially subjected to processing to form the protective layer by the processing device 40. The printing system 1 of the present embodiment suppresses the decrease in efficiency of performing operations on the can bodies 100.

Each component of the printing system 1 of the present embodiment will be described in detail below.

### [Can Body 100]

Here, the can body 100 to be printed by the printing system 1 of the present embodiment will be described. The can body 100 is formed into a closed-end cylindrical shape. The can body 100 includes a side surface 100s, which is a cylindrical portion (refer to FIG. 3 below). The can body 100 also includes an opening part 100t at one end side of an axial direction, to which a can lid is attached (refer to FIG. 3 below). Furthermore, the can body 100 includes a bottom part 100b at the other end side of the axial direction, by which the other end side is closed (refer to FIG. 3 below).

The can body 100 of the present embodiment is made of metal. Examples of the material of the can body 100 can include metals such as aluminum, an aluminum alloy, and steel.

### [Can Body Supply Section 10]

The can body supply section 10 shown in FIG. 1 acquires the plural can bodies 100 from a can manufacturing machine that manufactures the can bodies 100 by, for example, a draw and ironing (DI) molding. Then, the can body supply section 10 supplies the plural can bodies 100 to the first printing device 21, the second printing device 22 and the third printing device 23, respectively.

### [Printing Device 20]

As shown in FIG. 2, the printing device 20 includes a conveyance section 24 that conveys the can bodies 100, and a first printing unit 25 that performs printing on the can bodies 100 using plural first inkjet heads 250 (described below), and a second printing unit 26 that performs printing on the can bodies 100 using plural second inkjet heads 260 (described below).

### [Conveyance Section 24]

As shown in FIG. 2, the conveyance section 24 includes plural moving units 241 that hold the can bodies 100 and move the can bodies 10 individually, and a guide rail 242 that guides the movement of each moving unit 241.

As shown in FIG. 3, the moving unit 241 includes a mandrel 241M inserted inside the can bodies 100, a motor with a brake 241D that rotates the mandrel 241M in a circumferential direction and stops the rotation of the mandrel 241M, and a unit base 241B that supports these parts.

The mandrel 241M is formed in a cylindrical shape. The mandrel 241M is inserted into the can body 100 through the opening part 100t of the can body 100 to support the can body 100. The mandrel 241M is arranged in a lying state (a state along a horizontal direction). Thus, the can body 100 is also arranged in the lying state in the present embodiment.

Furthermore, the mandrel 241M includes a suction mechanism (not shown) to suck air inside. Thus, the mandrel 241M firmly holds the can body 100 even when the mandrel 241M is rotated or conveyed.

The rotation of the motor with the brake 241D is controlled by the control section 60 (refer to FIG. 1). In particular, the motor with the brake 241D rotates the can body 100 in the circumferential direction when the printing is performed on the can body 100 by the first printing unit 25 and the second printing unit 26.

The unit base 241B includes a permanent magnet (not shown) inside. The unit base 241B moves by attraction and repulsion of the permanent magnet inside caused by excitation of the guide rail 242.

The guide rail 242 of the present embodiment is formed linearly. The unit base 241B is movably fitted into the guide rail 242. Thus, the guide rail 242 guides a direction of movement of the moving unit 241. Furthermore, the guide rail 242 includes an electromagnet (not shown) for moving the moving unit 241. The timing of the excitation of the electromagnet of the guide rail 242 is controlled by the control unit 60 (refer to FIG. 1). In this way, the can body 100 is conveyed by a linear mechanism in the conveyance section 24.

In the conveyance section 24, the moving unit 241 holds the can body 100 so that the can body 100 is along the horizontal direction. In addition, the moving unit 241 is arranged on the guide rail 242 so that the axial direction of the can body 100 is along a longitudinal direction of the guide rail 242. Thus, the can body 100 is conveyed along the axial direction of the can body 100.

It should be noted that the movement of the moving unit 241 is not limited to the linear mechanism, but other mechanisms may be used. For example, each of the moving units 241 may be provided with a driving source such as a motor so that each of the moving units 241 may move by itself.

### (First Printing Unit 25)

The first printing unit 25 performs printing on the can body 100 using an inkjet printing method. The inkjet printing method refers to an image formation method performed by ejecting ink from a head to attach the ink to the can body 100. The printing by the inkjet printing method can use, for example, a piezo system, a thermal (bubble) system, and a continuous system.

As shown in FIG. 4A, the first printing unit 25 includes a cyan head 25C that ejects cyan ink, a magenta head 25M that ejects magenta ink, a yellow head 25Y that ejects yellow ink, and a black head 25K that ejects black ink.

When the cyan head 25C, the magenta head 25M, the yellow head 25Y, and the black head 25K are not distinguished from each other, these inkjet heads are simply referred to as the “first inkjet heads 250”.

Furthermore, the first printing unit 25 includes a first light irradiation section 500 that irradiates the can body 100, on which the ink has been ejected from the first inkjet head 250, with light.

Each of the first inkjet heads 250 is arranged along a moving direction of the can body 100. Specifically, the first inkjet heads 250 are arranged so that plural ejection holes that eject ink respectively are aligned along the axial direction of the can body 100. The first inkjet heads 250 are provided over the entire side surface 100s between the opening part 100t and the bottom part 100b of the can body 100 in the axial direction of the can body 100 (refer to FIG. 2).

When the first inkjet heads 250 perform printing, the can body 100 does not move in the axial direction of the can body 100. On the other hand, when the first inkjet heads 250 perform printing, the can body 100 rotates in the circumferential direction. Note that, in the present embodiment, since an image is formed on the entire side surface 100s (refer to FIG. 3) of the can body 100, the can body 100 makes at least one rotation in the circumferential direction when the first inkjet heads 250 perform printing.

When the first printing unit 25 performs printing, the can body 100 conveyed by the conveyance section 24 stops at the lower side of the first inkjet head 250. At this time, the can body 100 stops moving as for a position in the moving direction of the moving unit 241, but the can body 100 rotates in the circumferential direction. In other words, the can body 100 rotates with the axial direction as a rotation axis.

In the present embodiment, the can body 100 moves in a state that the axial direction of the can body 100 is along the horizontal direction, and an uppermost part of an outer circumferential surface of the can body 100 faces the upper side in the up-and-down direction. Then, each of the first inkjet heads 250 of the present embodiment ejects ink toward the side surface 100s of the can body 100 from the upper side to the lower side, to thereby perform printing on the can body 100.

The first printing unit 25 ejects ink toward the can body 100 using all or part of the first inkjet heads 250 according to the content of the image formed on the can body 100.

As shown in FIG. 4A, the first light irradiation section 500 of the present embodiment is provided at a side that is opposite the installation locations of the plural first inkjet heads 250 across the can body 100. In the present embodiment, the plural first inkjet heads 250 are arranged on the upper side with respect to the can body 100. Therefore, the first light irradiation section 500 is arranged on the lower side with respect to the can body 100.

The first light irradiation section 500 includes a light source 500A that emits ultraviolet light, and emits the ultraviolet light to the side surface 100s of the can body 100, on which a printed image has been formed by the first inkjet heads 250. Thus, the printed image on the side surface 100s of the can body 100 is cured. Specifically, the first light irradiation unit 500 is arranged on the lower side of the can body 100, emits the ultraviolet light toward the upper side, and cures the printed image from the lower side of the can body 100.

Here, the ultraviolet light emitted from the first light irradiation section 500 in the present embodiment is blocked by the can body 100, which makes it difficult for the ultraviolet light to reach the plural first inkjet heads 250. In other words, in the present embodiment, as shown in FIG. 4A, the can body 100 is positioned between the first light irradiation section 500 and the plural first inkjet heads 250, so that the ultraviolet light from the first light irradiation section 500 is not directly incident on the plural first inkjet heads 250.

This prevents clogging of the first inkjet heads 250 caused by the ultraviolet light reaching the first inkjet heads 250.

Furthermore, as shown in FIG. 4A, when the can body 100 is at a position facing the first light irradiation section 500, the first light irradiation section 500 of the present embodiment turns on the light source 500A and emits the ultraviolet light to the side surface 100s of the can body 100. Specifically, the first printing unit 25 includes a sensor (not shown) that detects the can body 100 is at the position facing the first light irradiation section 500. When the can body 100 is detected by the sensor in the first printing unit 25, the first light irradiation section 500 turns on the light source 500A.

When the can body 100 does not exist at the position facing the light source 500A, the first light irradiation section 500 turns off the light source 500A or reduces the output of the light source 500A. Specifically, when the can body 100 is not detected by the sensor, the first light irradiation section 500 turns off the light source 500A or reduces the output of the light source 500A. In this way, when the can body 100 does not exist at the position facing the light source 500A, the light source 500A is turned off or the output of the light source 500A is reduced so that the ultraviolet light does not reach the first inkjet heads 250.

When the first printing unit 25 prints on the can body 100, a thermosetting ink may be used. In this case, for example, a heat source such as a heat generating lamp instead of the light source can be installed at the place where the first light irradiation section 500 is provided. In the case of using the heat source, output control such as turning on and off of the heat source based on the sensor that detects the can body 100 can be performed in the same manner as the light source 500A described above.

### (Second Printing Unit 26)

As shown in FIG. 2, the second printing unit 26 is arranged downstream of the first printing unit 25 in a conveyance direction of the can body 100 by the conveyance section 24.

Then, as shown in FIG. 4B, the second printing unit 26 includes a first white head 26W1 that ejects white ink, a second white head 26W2 that ejects white ink separately from the first white head 26W1, a transparent head 26T that ejects transparent ink, and a special color head 26S that ejects ink of a special color such as a corporate color.

When the first white head 26W1, the second white head 26W2, the transparent head 26T, and the special color head 26S are not distinguished from each other, these inkjet heads are simply referred to as the “second inkjet heads 260”.

Furthermore, the second printing unit 26 includes a second light irradiation section 600 that irradiates the can body 100, on which the ink has been ejected from the second inkjet head 260, with light.

The basic configuration of the second printing unit 26 is the same as that of the first printing unit 25, except that, as described above, a configuration such as the color of the ink ejected to the can body 100 is different from that of the first printing unit 25.

As shown in FIG. 4B, the second light irradiation unit 600 is provided at a side that is opposite the installation locations of the plural second inkjet heads 260 across the can body 100. In the present embodiment, the plural second inkjet heads 260 are arranged on the upper side with respect to the can body 100. Therefore, the second light irradiation section 600 is arranged on the lower side with respect to the can body 100.

The second light irradiation section 600 includes a light source 600A that emits the ultraviolet light. The second light irradiation section 600 emits the ultraviolet light to the side surface 100s of the can body 100, on which the printing has been performed by the second inkjet heads 260.

The second printing unit 26, configured as described above, further performs printing on the side surface 100s of the can body 100, on which the printing has been performed by the first printing unit 25. Thus, in the printing device 20 of the present embodiment, an image that cannot be expressed by the first printing unit 25 alone is formed on the can body 100 by using the second printing unit 26 including ink of a color that the first printing unit 25 does not include.

As described above, the first printing device 21 includes plural “printing units” (an example of a printing section) of the first printing unit 25 including the plural first inkjet heads 250 and the second printing unit 26 including the plural second inkjet heads 260. This is also the case for the second printing device 22 and the third printing device 23. The printing devices 20 of the present embodiment include the plural “printing units” having plural “inkjet heads”, respectively. Thus, the printing devices 20 of the present embodiment are intended to shorten a printing time for the can body 100 and to be reduced in size.

The first printing unit 25 and the second printing unit 26 are not limited to the configuration described above.

For example, the second printing unit 26 may be provided upstream of the first printing unit 25 in the conveyance direction of the can body 100. In this case, the second printing unit 26 forms a white layer on the side surface 100s of the can body 100, and then the first printing unit 25 can perform color printing using yellow, magenta, cyan and black. This allows the colors to be placed on top of the white layer formed as a base layer, which makes the colors look beautiful.

For example, a color configuration of the plural first inkjet heads 250 of the first printing unit 25 and the plural second inkjet heads 260 of the second printing unit 26 may be the same. In this case, the same color can be layered on the first printing unit 25 and the second printing unit 26, which expands the range of expression such as shading.

For example, the first inkjet heads 250 of the first printing unit 25 and the plural second inkjet heads 260 of the second printing unit 26 may have different head resolutions from each other. In this case, for example, so-called solid painting may be performed using the first printing unit 25, which has a lower resolution but a larger area of ink ejected from each ejection head, or a refined image may be formed using the second printing unit 26.

For example, a rotational speed in the circumferential direction of the can body 100 as rotated by the moving unit 241 may be different between the first printing unit 25 and the second printing unit 26. In this case, similar to the difference in the head resolution described above, the first printing unit 25 and the second printing unit 26 may be used separately for a refined image and an image that can be coarse.

Furthermore, a length of the head in the axial direction of the can body 100 may be different between the first inkjet heads 250 of the first printing unit 25 and the plural second inkjet heads 260 of the second printing unit 26. In this case, for example, the first printing unit 25 and the second printing unit 26 may be used separately for a relatively short can body 100 with a capacity of 350 ml and a relatively long can body 100 with a capacity of 500 ml.

Furthermore, an irradiation condition of the ultraviolet light may be different between the first light irradiation section 500 of the first printing unit 25 and the second light irradiation section 600 of the second printing unit 26. For example, an irradiation intensity of the ultraviolet light by the first light irradiation section 500 may be higher than that of the second light irradiation section 600. On the other hand, the irradiation intensity of the ultraviolet light by the second light irradiation section 600 may be higher than that of the first light irradiation section 500.

In addition, the first printing unit 25 and the second printing unit 26 need not include the first light irradiation section 500 and the second light irradiation section 600, respectively. For example, the first printing unit 25 may not include the first light irradiation section 500, and only the second printing unit 26 provided downstream in the conveyance direction of the can body 100 may include the second light irradiation section 600.

The above-described plural characteristic configurations based on the differences between the first light irradiation section 500 and the first inkjet heads 250 of the first printing unit 25, and the second light irradiation section 600 and the second inkjet heads 260 of the second printing unit 26 may be combined with each other.

### [Modified Example of Printing Device 20]

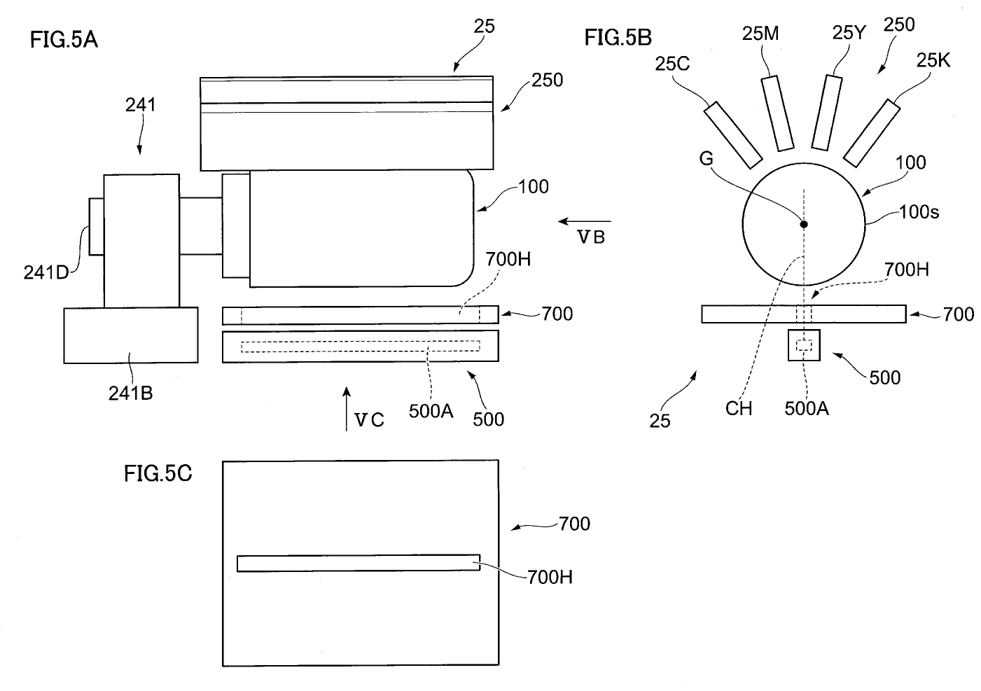

FIGS. 5A, 5B and 5C are illustration diagrams of the printing device 20 of a modified example.

FIG. 5A is a side view of the first printing unit 25 and the moving unit 241. FIG. 5B is a diagram of the first printing unit 25 and the moving unit 241 as viewed in a direction indicated by an arrow VB in FIG. 5A. FIG. 5C is a diagram of a shielding member 700 as viewed in a direction indicated by an arrow VC in FIG. 5A.

The following modified example will be described using the first printing unit 25 as an example, but it can also be applied to the second printing unit 26.

As shown in FIG. 5A, the first printing unit 25 of the modified example includes the shielding member 700 that shields light from the first light irradiation section 500 to the first inkjet heads 250.

The shielding member 700 of the present embodiment reduces the ultraviolet light that passes through both opposite sides of the can body 100 shown in FIG. 5B and toward the first inkjet heads 250.

The shielding member 700 is provided between the first light irradiation section 500 and the first inkjet heads 250 as shown in FIG. 5A and FIG. 5B. The shielding member 700 is formed in a plate shape as shown in FIG. 5C. It should be noted that the shape and a material of the shielding member 700 are not particularly limited as long as it does not transmit the ultraviolet light. The shielding member 700 is not limited to the plate shape, but may be formed in a sheet shape. In addition, examples of the material of the shielding member 700 can include metal or resin. The shielding member 700 further reduces the light directed from the first light irradiation section 500 to the first inkjet heads 250.

As shown in FIG. 5C, the shielding member 700 includes a light transmission section 700H that opens to pass light from the first light irradiation section 500 to the can body 100. As shown in FIG. 5B, the light transmission section 700H is positioned on a straight line CH connecting the light source 500A and an axial center G of the can body 100. In other words, the light transmission section 700H is positioned on an optical path of the ultraviolet light from the light source 500A to the can body 100. With the light transmission section 700H being a starting point, the shielding member 700 is arranged to extend toward both the upstream and the downstream in the moving direction of the can body 100.

In the modified example, the light emitted from the light source 500A of the first light irradiation section 500 passes through the light transmission section 700H toward the side surface 100s of the can body 100 and is incident on the side surface 100s. Thus, as described above, the printed image on the side surface 100s of the can body 100 is cured.

### [Adjustment Section 30]

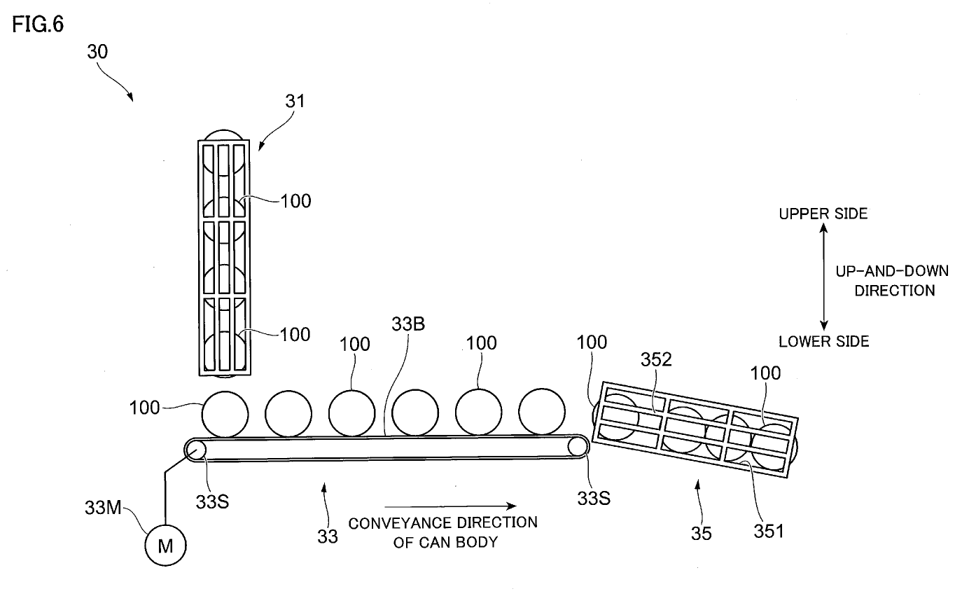

FIG. 6 is an overall diagram of the adjustment section 30 of the present embodiment.

As shown in FIG. 6, the adjustment section 30 of the present embodiment includes a collection section 31 that collects the can body 100 from the printing device 20, a first conveyance section 33 that conveys the can body 100 and a second conveyance section 35 that is provided downstream of the first conveyance section 33 in the conveyance direction of the can body 100 and conveys the can body 100.

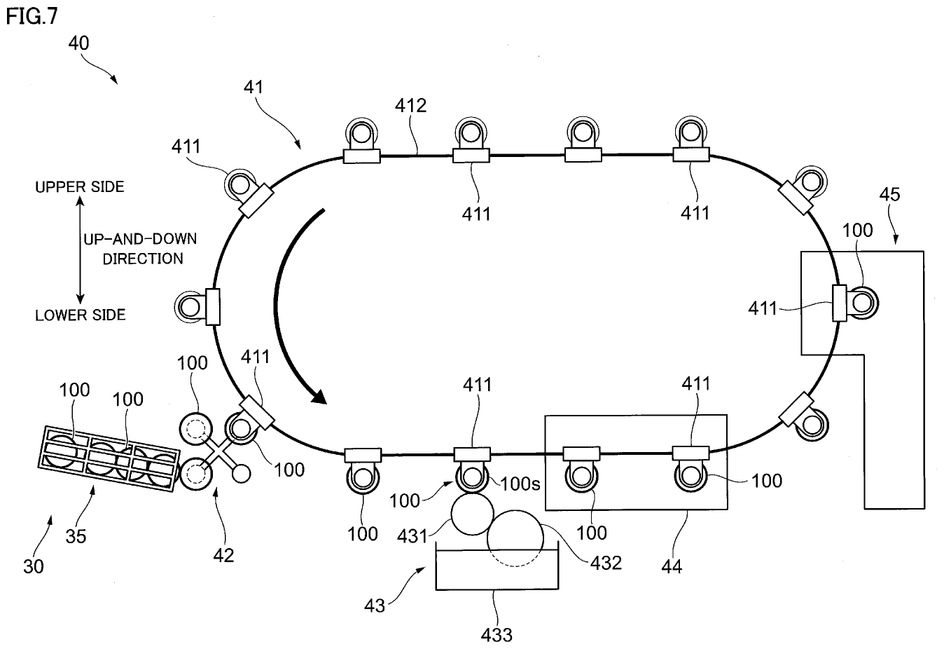

Then, the adjustment section 30 of the present embodiment collects the plural printed can bodies 100, on which the printing has been performed by the plural printing devices 20 respectively, and adjusts the intervals of conveyance of the plural can bodies 100. The adjustment section 30 passes the plural can bodies 100 whose intervals of conveyance has been adjusted to the subsequent processing device 40 (refer to FIG. 7).

### (Collection Section 31)

The collection section 31 is connected to the downstream in the conveyance direction of the can body 100 in the first printing device 21, the second printing device 22, and the third printing device 23 (refer to FIG. 1), respectively. The collection section 31 collects the plural printed can bodies 100 which have been formed by each printing devices 20 from the first printing device 21, the second printing device 22, and the third printing device 23. Then, the collection section 31 converges the plural can bodies 100 which have been collected from the first printing device 21, the second printing device 22, and the third printing device 23 respectively. Further, the collection section 31 sends the plural converged can bodies 100 to the first conveyance section 33.

### (First Conveyance Section 33)

The first conveyance section 33 includes an endless belt 33B and plural supporting shafts 33S around which the belt 33B is hung, and a drive motor 33M that drives the supporting shafts 33S. The first conveyance section 33 actively conveys the can body 100 using power by the drive motor 33M (an example of a driving source).

The belt 33B can place the plural can bodies 100 on a belt surface facing upward. The upper belt surface of the belt 33B of the present embodiment is formed along a horizontal plane. Examples of the material of the belt 33B can include synthetic rubber, which can convey the can bodies 100 without deformation or other defects.

The supporting shafts 33S are provided apart by a predetermined distance with their axial directions being approximately parallel. The belt 33B is hung around the supporting shafts 33S.

The drive motor 33M is connected to the supporting shafts 33S and rotates the supporting shafts 33S. The rotation of the drive motor 33M is controlled by the control section 60 (refer to FIG. 1).

The first conveyance section 33 rotates the belt 33B so that the can bodies 100 placed on the upper belt surface of the belt 33B moves from the upstream collection section 31 to the downstream second conveyance section 35. The first conveyance section 33 conveys the plural can bodies 100 received from the collection section 31 toward the second conveyance section 35. In this way, the first conveyance section 33 conveys the can bodies 100 without holding the can bodies 100 so that the can bodies 100 themselves can move freely, instead of inserting, for example, mandrels inside the can bodies 100 and conveying in a state that the can bodies 100 are individually held. In other words, the first conveyance section 33 conveys the plural can bodies 100 in a state that the intervals between the plural can bodies 100 are allowed to change.

In addition, a conveying speed of the can bodies 100 by the first conveyance section 33 is set faster than the conveying speed of the second conveyance section 35.

### (Second Conveyance Section 35)

The second conveyance section 35 includes a conveyance path 351 through which the can bodies 100 are conveyed and a guide section 352 which guides the movement of the can bodies 100.

The conveyance path 351 is inclined so that a position of the first conveyance section 33 side is relatively high and a position of the processing device 40 (refer to FIG. 7 below) side is relatively low. One end of the conveyance path 351 is connected to the first conveyance section 33, and the other end is connected to a can body feeding section 42 (refer to FIG. 7 below) of the processing device 40, which will be described later. The conveyance path 351 conveys the plural can bodies 100 from the first conveyance section 33 toward the processing device 40 by rolling the can bodies 100 under their own weight. In this way, the second conveyance section 35, like the first conveyance section 33, conveys the can bodies 100 without holding them. In other words, the second conveyance section 35 conveys the plural can bodies 100 in a state that the can bodies 100 themselves can move freely and the intervals between the plural can bodies 100 are allowed to change.

The guide sections 352 guide directions of the can bodies 100 so that the can bodies 100 can move while rolling under their own weight in the conveyance path 351. The guide sections 352 are provided on the opening part 100t side and the bottom part 100b side of the can bodies 100, respectively. The guide sections 352 guide the can bodies 100 so that the plural can bodies 100 line up side by side in the conveyance path 351 with the axial directions of the can bodies 100 intersecting (for example, orthogonal to) the conveyance path 351.

The conveying speed of the can bodies 100 by the second conveyance section 35 is slower than that of the first conveyance section 33. As described above, the second conveyance section 35 is provided downstream of the first conveyance section 33 in the conveyance direction of the can bodies 100. Thus, the second conveyance section 35 narrows the intervals of conveyance between the plural can bodies 100.

In this way, the adjustment section 30 makes the intervals of conveyance between the plural can bodies 100 shorter than the intervals of conveyance between the plural can bodies 100 when the printing is performed by one printing device 20 (for example, one of the first printing device 21, the second printing device 22 and the third printing device 23).

### [Processing Device 40]

FIG. 7 is an overall diagram of the processing device 40 of the present embodiment.

As shown in FIG. 7, the processing device 40 includes a processing conveyance section 41 that conveys the can body 100 and the can body feeding section 42 that feeds the can body 100 into the processing conveyance section 41. The processing device 40 also includes a painting section 43 that paints the side surface 100s of the can body 100, a drying section 44 that dries the painted can body 100, a can body discharging section 45 that discharges the painted can body 100 from the processing conveyance section 41.

The processing unit 40 performs processing to form the protective layer protecting an outer surface (for example, the side surface 100s) of the can body 100 on each of the can bodies among the plural can bodies 100 whose intervals of conveyance have been adjusted by the adjustment section 30.

The processing conveyance section 41 includes plural moving units 411 that hold each of the can bodies 100 and move the can bodies 100 and a guide rail 412 that guides the movement of each moving unit 411.

The basic configuration of the moving units 411 and the guide rail 412 of the processing conveyance section 41 in the present embodiment is the same as that of the moving units 241 and the guide rail 242 of the conveyance section 24 described above (refer to FIG. 2).

The moving units 411, like the moving units 241, hold the can bodies 100 by inserting the mandrels into the can bodies 100 (refer to FIG. 3). In the processing conveyance section 41, like the conveyance section 24, the moving unit 411 holds the can bodies 100 in the lying states along the horizontal direction.

However, in the processing conveyance section 41, the guide rail 412 is formed in a loop shape with straight sections and circular arc sections. The moving unit 411 moves along the loop shaped conveyance path. In addition, the moving unit 411 holds the can bodies 100 in a direction in which the axial directions of the can bodies 100 are intersecting (for example, orthogonal to) the conveyance direction. In this way, the directions of the can bodies 100 when the can bodies 100 are conveyed by the processing conveyance section 41 are different from the directions of the can bodies 100 in which they are conveyed by the conveyance section 24 (refer to FIG. 2) during the printing on the can bodies 100.

The can body feeding section 42 receives the can body 100 from the adjustment section 30 and attaches the can body 100 to the moving unit 411 of the processing conveyance section 41. In other words, the can body feeding section 42 sequentially feeds the plural can bodies 100 whose intervals of conveyance have been adjusted by the adjustment section 30, into the processing conveyance section 41.

The painting section 43 includes a contact roll 431 that rotates while contacting the rotating can body 100, a supply roll 432 that supplies paint for use as the protective layer to a surface of the contact roll 431, and a housing section 433 that contains the paint.

In the painting section 43, the paint in the housing section 433 is supplied to the contact roll 431 by the supply roll 432. Then, the contact roll 431 applies the paint to the side surface 100s of the can body 100. The painting section 43 in the present embodiment applies transparent paint to the side surface 100s of the can body 100 to form the protective layer on the outer surface of the can body 100.

The drying section 44 includes infrared heaters (not shown) as a heating source. The infrared heaters are installed at plural locations in the moving direction of the moving unit 411. The drying section 44 heats the can body 100 while the moving unit 411 moves through the drying section 44. Thus, the drying section 44 cures the protective layer formed on the can body 100.

The can body discharging section 45 discharges the can body 100 whose protective layer has been cured by the drying section 44, from the processing conveyance section 41. Then, the can body discharging section 45 passes the discharged can body 100 to the accumulation section 50.

Then, the processing device 40 of the present embodiment forms the protective layer for each of the can bodies 100. The number of operations per unit of time for the can bodies 100 by the processing device 40 of the present embodiment is the same as the number of operations per unit of time for the can bodies 100 by the above-described plural printing devices 20 as a whole (for example, the first printing device 21, the second printing device 22 and the third printing device 23).

### [Accumulation Section 50]

The accumulation section 50 accumulates the plural can bodies 100 which have been discharged from the processing conveyance section 41 by the can body discharging section 45.

The accumulation section 50 passes the accumulated plural can bodies 100 in response to a request from a process provided at a subsequent stage.

### [Control Section 60]

The control section 60 shown in FIG. 1 includes a CPU (Central Processing Unit), which is an arithmetic unit, and a ROM (Read Only Memory), which is a storage area for storing programs such as BIOS (Basic Input Output System), and a RAM (Random Access Memory), which is an execution area for programs. The control unit 60 also includes a non-volatile memory such as HDD (Hard Disk Drive) or flash memory, which is a storage area for storing various programs such as an OS (Operating System) and applications, input data for various programs and output data from various programs. The control section 60 includes plural CPUs, and the plural CPUs may perform arithmetic processing in cooperation.

The control section 60 controls the operation of the can body supply section 10, the printing device 20, the processing device 40, and the accumulation section 50 based on content of a predetermined program, position information such as the positions of the moving unit 241 and the moving unit 411 as detected by various sensors (not shown) and an operation information of each device and component.

Subsequently, an operation of the printing system 1 of the present embodiment will be described.

In the printing system 1 shown in FIG. 1, the can body supply section 10 respectively supplies the plural can bodies 100 to the plural printing devices 20 (the first printing device 21, the second printing device 22, and the third printing device 23). Then, each of the printing devices 20 performs printing on the plural can bodies 100. Furthermore, the plural can bodies 100, on which the printing has been performed respectively by the plural printing devices 20, are collected in the adjustment section 30.

The printing device 20 of the present embodiment performs the printing using the inkjet method as described above. In the case of the inkjet method, since it is not necessary to prepare an original printing plate in advance as in the case of a plate printing method, for example, it is easy to change printing content for each can body 100. Thus, the content of the images printed on the can bodies 100 may be the same or different among the plural can bodies 100, on which the printing is performed by the first printing device 21, for example. Also, the content of the images printed on the can bodies 100 may be the same or different, for example, between the first printing device 21 and the second printing device 22.

As shown in FIG. 6, in the adjustment unit 30, the collection section 31 collects the plural can bodies 100 from the plural printing devices 20 (refer to FIG. 1). Furthermore, the plural can bodies 100 which have been collected by the collection section 31 are conveyed to the second conveyance section 35 by the first conveyance section 33. Here, as described above, the conveying speed of the can bodies 100 by the first conveyance section 33 is faster than that of the second conveyance section 35. Due to the difference in the conveying speed, the intervals between the plural can bodies 100 in the second conveyance section 35 are narrowed, reducing the intervals between the plural can bodies 100 in the second conveyance section 35. In this way, the adjustment section 30 adjusts the intervals of conveyance of the plural can bodies 100.

The adjustment section 30 conveys the can bodies 100 without holding them when adjusting the intervals of conveyance.

Here, in the printing device 20, each can body 100 is held by the moving unit 241 of the conveyance section 24. On the other hand, in the processing device 40, each can body 100 is held by the moving unit 411 of the processing conveyance section 41. The number of operations per unit of time for the can bodies 100 is different between the printing device 20 and the processing device 40. According to the difference in the number of operations per unit of time, the conveying speeds of each “moving unit” are different between the printing device 20 and the processing device 40. Thus, it is difficult to convey the can bodies 100 using the “moving unit” of the same conveyance system in the printing device 20 and the processing device 40 from the viewpoint of a mechanism and control of the device.

Also, in the printing system 1 of the present embodiment, the printing device 20 conveys the can body 100 in the axial direction of the can body 100 and performs the printing on the can body 100. On the other hand, the processing device 40 conveys the can body 100 in the direction intersecting the axial direction of the can body 100 and perform processing on the can body 100. Thus, the direction of the can body 100 when conveying the can body 100 is also different between the printing device 20 and the processing device 40.

Thus, in the printing system 1 of the present embodiment, the adjustment section 30 is provided between the printing device 20 and the processing device 40 whose conveying speeds and directions of the can bodies 100 during conveyance are different. The adjustment section 30 conveys the can bodies 100 without holding them, so that the can bodies 100 can be passed between the devices whose configurations regarding conveyance of the can bodies 100 are different.

Then, the processing device 40 receives the plural can bodies 100 whose intervals of conveyance are made narrower by the adjustment section 30 than, for example, the intervals of conveyance of the plural can bodies 100 by each printing device 20. The processing device 40 performs processing to form the protective layer respectively on the plural can bodies 100. In this case, the number of operations per unit of time for the can bodies 100 by the processing device 40 is larger than that of the single one of the printing devices 20. However, in the printing system 1 of the present embodiment, the decrease in efficiency of performing operations on the plural can bodies 100 is suppressed regardless of the difference in the operating capacity of the individual devices by using the plural printing devices 20 in parallel to perform printing on the plural can bodies 100, and by further adjusting the intervals of conveyance of the can bodies 100 by the adjustment section 30.

In the present embodiment, the printing device 20 using the inkjet method is used as an example, but a printing method in the printing device 20 is not limited to the inkjet method, and other printing methods can be used. However, the number of operations to be printed per unit of time in the inkjet printing method as in the present embodiment is relatively small, compared with, for example, the plate printing. Thus, by applying the printing system 1 of the present embodiment to the case of using the inkjet printing device 20, the effect of suppressing the decrease in efficiency of performing operations on the can bodies 100 can be facilitated.

Although the present embodiment has been described above, the technical scope of the present invention is not limited to the scope described in the aforementioned embodiment. It is apparent from the description of the claims that various modifications or improvements to the above described embodiment are also included in the technical scope of the present invention.

### REFERENCE SIGNS LIST

1 Printing system
10 Can body supply section
20 Printing device
21 First printing device
22 Second printing device
24 Conveyance section
25 First printing unit
26 Second printing unit
30 Adjustment section
31 Collection section
33 First conveyance section
35 Second conveyance section
40 Processing device
41 Processing conveyance section
50 Accumulation section
100 Can body
241 Moving unit
5 242 Guide rail
250 First inkjet head
260 Second inkjet head
500 First light irradiation section
500A Light source
10

1. A printing system comprising:
a first printing device configured to perform printing on a can body;
a second printing device provided in parallel with the first printing device and configured to perform the printing on the can body;
an adjustment section configured to collect a plurality of can bodies having undergone the printing by the first printing device and the second printing device and adjust intervals of conveyance of the plurality of can bodies; and
a processing device configured to perform processing to form a protective layer protecting an outer surface of each of the plurality of can bodies obtained from the adjusting section.

2. The printing system according to claim 1, wherein
the first printing device and the second printing device each perform the printing on the can body using an inkjet head.

3. The printing system according to claim 1, wherein
the adjustment section conveys the can body without holding the can body.

4. The printing system according to claim 3, wherein
the adjustment section comprises:
a first conveyance section configured to convey the can body using power of a driving source; and
a second conveyance section provided downstream of the first conveyance section in a conveyance direction of the can body and configured to convey the can body using a conveyance path on which the can body rolls.

5. The printing system according to claim 4, wherein
the second conveyance section has a lower conveying speed than the first conveyance section.

6. The printing system according to claim 2, wherein
the first printing device and the second printing device each include a plurality of printing sections with a plurality of inkjet heads.

7. The printing system according to claim 1, wherein
the first printing device and the second printing device each convey the can body along an axial direction of the can body to perform the printing on the can body, and
the processing device conveys the can body in a direction intersecting the axial direction of the can body to perform the processing on the can body.

8. The printing system according to claim 2, wherein
the adjustment section conveys the can body without holding the can body.

9. The printing system according to claim 8, wherein
the adjustment section comprises:
a first conveyance section configured to convey the can body using power of a driving source; and
a second conveyance section provided downstream of the first conveyance section in a conveyance direction of the can body and configured to convey the can body using a conveyance path on which the can body rolls.

10. The printing system according to claim 9, wherein
the second conveyance section has a lower conveying speed than the first conveyance section.
